(19) United States
(12) Patent Application Publication
(10) Pub. No.: US 2007/0112496 A1
(43) Pub. Date: May 17, 2007

(54) Apparatus and method for controlling driving of hybrid electric vehicle on slope

(76) Inventor: Sang Woo Ji, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/300,156

(22) Filed: Dec. 13, 2005

(30) Foreign Application Priority Data
Nov. 17, 2005 (KR) 2005-0110147

(51) Int. Cl. G06G 7/76

(52) U.S. Cl. 701/70

(57) ABSTRACT

An apparatus and a method for controlling driving of a hybrid electric vehicle on a slope are disclosed. With the apparatus and the method, the hybrid electric vehicle travels on the slope in one mode selected from an engine-motor combined driving mode, an engine driving mode, and a motor driving mode according to an SOC of the battery and a degree of the slope. Accordingly, when traveling on the slope, a driving mode can be determined according to the degree of the slope and the SOC of the battery, thereby previously preventing motor torque from being abruptly increased while traveling on the slope. As a result, a travel distance of the electric motor can be increased, and the start of the internal combustion engine is minimized, thereby enhancing the fuel efficiency by reducing the fuel consumption.

### CROSS-REFERENCE TO RELATED APPLICATION

This application claims priority to and the benefit of Korean Patent Application 10-2005-0110147 filed in the Korean Intellectual Property Office on Nov. 17, 2005, the entire content of which is incorporated herein by reference.

### BACKGROUND OF THE INVENTION

1. Field of the Invention

The present invention generally relates to a hybrid electric vehicle (HEV), and, more particular, to an apparatus and a method for controlling driving of a hybrid electric vehicle on a slope, which can determine a driving mode according to a degree of the slope and a state of charge (which will also be referred to as an “SOC”) in a battery when traveling on the slope, thereby obtaining improvement in travel distance of an electric motor, and in fuel efficiency.

2. Description of the Related Art

A hybrid electric vehicle refers to an automobile, which has a driving force output from both an internal combustion engine and a motor. Since the hybrid electric vehicle can remarkably reduce detrimental emission in comparison to typical automobiles comprising only the internal combustion engine, it is usually referred to as an “echo-car.”

Referring to FIG. 1, a power train in a conventional hybrid electric vehicle comprises an internal combustion engine 1, an engine clutch 2 connected to an output terminal of the internal combustion engine 1, a carrier gear 3 connected to the engine clutch 2, a sun gear 6 connected to a generator 7, a ring gear 4 connected to an electric motor 5, and a pinion gear 9 connected to the ring gear 4 and the sun gear 6, and to the carrier gear 3. The electric motor 5 and the generator 7 can be provided as an Integrated Starter & Generator (ISG) structure which can ensure both electric generation and power supply. In FIG. 1, “B” indicates a bearing.

With the construction as described above, the hybrid electric vehicle is able to travel with different traveling modes selected according to travel speeds, as shown in FIGS. 2a to 2e.

Upon start and low speed travel of the hybrid electric vehicle, driving wheels W of the vehicle are rotated by driving force from the electric motor 5 to which electric power is supplied from a battery 8, as shown in FIG. 2a. During typical traveling, the hybrid electric vehicle is driven via combination of the internal combustion engine 1 and the electric motor 5 according to the travel speed, as shown in FIG. 2b. In particular, upon traveling at a high speed, the wheels W of the vehicle are rotated by a driving force from the internal combustion engine 1, and electric power from the electric motor 5 in which the electric power from the electric motor 5 is added to the driving force of the internal combustion engine 1. In addition, upon reducing the travel speed of the vehicle, the battery 8 is charged using the electric motor 5 as a generator, and draws energy from the electric motor 5, as shown in FIG. 2c, and when stopping the vehicle, the operation of the engine and the electric motor is automatically stopped, thereby reducing unnecessary fuel consumption, and emissions.

However, vehicle traction force required for driving of the vehicle is determined by not only the travel speed, but also the slope of a road on which the hybrid electric vehicle is traveling. In this regard, the conventional hybrid electric vehicle has a problem in that the driving modes thereof can be selected only according to the travel speed.

FIG. 3 shows combinations of an engine and a transmission according to driving conditions, in which a driving force of the vehicle is obtained by the following Equation:
F=T0×TGR×N/R

Here, T0 indicates an engine output torque, TGR indicates an overall gear ratio, N indicates overall transmission efficiency, and R indicates a dynamic radius of a tire.

Driving force F required for setting respective elements in a motor driving mode corresponding to a first speed can be obtained, and is the same as a motor driving torque of the hybrid electric vehicle. However, as shown in FIG. 3, when traveling on a slope, the driving force required for the first speed is abruptly increased as the slope is increased, and there easily comes limit in which the vehicle cannot be driven only with the electric motor due to an abrupt increase of the motor torque, so that a travel distance only with the electric motor is decreased, thereby requiring the running of the internal combustion engine. As a result, the conventional hybrid electric vehicle has a problem in that fuel consumption is increased upon traveling on the slope due to the running of the engine thereon, thereby reducing the fuel efficiency of the vehicle.

### SUMMARY OF THE INVENTION

The present invention has been made to solve the above problems, and it is an object of the present invention to provide an apparatus and a method for controlling driving of a hybrid electric vehicle on a slope, which can determine a driving mode according to a degree of the slope, and an SOC of a battery when traveling on the slope in order to prevent an abrupt increase in motor torque due to traveling on the slope, and discharge of the battery caused by the abrupt increase of the motor torque, thereby improving the travel distance of an electric motor, and the fuel efficiency.

In accordance with one aspect of the present invention, the above and other objects can be accomplished by the provision of an apparatus for controlling driving of a hybrid electric vehicle on a slope, comprising: an acceleration position sensor to detect a position of an accelerator pedal and output the position as an electric signal; a brake pedal sensor to detect operation of the break pedal and output the operation as an electric signal; a slope degree sensor to detect a slope degree and output the slope degree as an electric sensor; a battery state of charge (SOC) sensor to detect an SOC of a battery and output the SOC as an electric signal; a hybrid electric vehicle control unit to receive the electric signals input from the acceleration position sensor, the brake pedal sensor, the slope degree sensor, and the SOC sensor, and to output control signals thereto; and a driving unit to drive an engine, a generator, and an electric motor, wherein, when the hybrid electric vehicle travels on a slope, the hybrid electric vehicle control unit selects one driving mode among an engine-motor combined driving mode, an engine driving mode, and a motor driving mode by using the electric signals input from the slope degree sensor and the SOC sensor, and controls the driving unit with the selected mode.

The driving unit comprises an engine control unit to control the engine according to the control signal from the hybrid electric vehicle control unit, a generator control unit to control the generator according to the control signal from the hybrid electric vehicle control unit, and an electric motor control unit to control the electric motor according to the control signal from the hybrid electric vehicle control unit. The engine control unit comprises an engine ECU, and when comprising an ISC simultaneously entering functions of the generator and the electric motor, the generator and the electric motor may be integrated to a single component, and the ISG may comprise a plurality of ISGs, which output different optimum driving torques.

Meanwhile, the hybrid electric vehicle control unit further comprises a charge control unit to output a control signal to the battery. After receiving the electric signal from the SOC sensor, the charge control unit determines whether or not the battery is charged, and controls the SOC in the battery according to the control signal from the hybrid electric vehicle control unit.

According to the present invention, the hybrid electric vehicle control unit may determine whether or not the hybrid electric vehicle travels in a driving mode by using the electric signals input from the acceleration position sensor and the brake pedal sensor, and if it is determined that the hybrid electric vehicle travels on the slope by using the electric signal input from the slope degree sensor in the driving mode, the hybrid electric vehicle control unit may select one mode among the engine-motor combined driving mode, the engine driving mode, and the motor driving mode. Here, the slope driving mode is performed when the acceleration pedal is operated and the break pedal is not operated upon traveling on the slope.

Meanwhile, the hybrid electric vehicle control unit may be provided with a table comprising a plurality of control regions divided by a slope degree axis divided into a plurality of preset slope degrees, and by an SOC axis divided into a plurality of preset SOCs, and among the control regions of the table, a control region with a relatively high SOC and a relatively low slope degree is determined as the motor driving mode, a control region with a relatively low SOC and a relatively high slope degree is determined as the engine driving mode, and a control region between the control region respectively determined as the motor driving mode and the engine driving mode is determined as the engine-motor combined driving mode.

More specifically, the control regions of the table may be divided by the slope degree axis divided into 5 degrees, 10 degrees, 15 degrees, and 20 degrees, and by the SOC axis divided into 40%, 60%, 80%, and 100%. Among the control regions, a control region of slope degree<10° and 60%≦SOC<100% is determined as the motor driving mode, a control regions of slope degree≧5° and SOC<40% and a control region of slope degree≧10° and SOC<60%, are determined as the engine driving mode, and the remaining control regions are determined as the engine-motor combined driving mode.

In accordance with another aspect of the present invention, a method for controlling driving of a hybrid electric vehicle on a slope is provided, the method comprising the steps of: determining whether or not the hybrid electric vehicle travels on a slope of a preset slope degree or more by using a signal input from a slope degree sensor; detecting an SOC of a battery by using a signal input from an SOC sensor, and a degree of the slope by using a signal input from the slope degree sensor if it is determined that the hybrid electric vehicle travels on the slope; and selecting one mode from an engine-motor combined driving mode, an engine driving mode, and a motor driving mode according to the detected SOC of the battery and the degree of the slope.

At the step of selecting the one mode, the battery serving to supply electric power to the electric motor according to the SOC of the battery and the degree of the slope does not reach a limit that the battery cannot supply the electric power to the electric motor, and more particularly, this is determined by the table described above.

Preferably, after the step of determining whether the hybrid electric vehicle travels on the slope, the method further comprises: entering a slope driving mode if it is determined that the hybrid electric vehicle travels on the slope, and if is it determined that the acceleration pedal is operated and the break pedal is not operated by using a signal input from the acceleration position sensor and the brake pedal sensor, followed by detecting an SOC of the battery and a degree of the slope.

Before determining whether or not the hybrid electric vehicle travels on the slope, the method of the present invention may further comprise the steps of: determining whether or not the acceleration pedal is operated by using a signal input from the acceleration position sensor when the hybrid electric vehicle starts to drive; entering a slow driving mode if it is determined that the acceleration pedal is not operated; determining whether or not the brake pedal is operated by using a signal input from the brake pedal sensor if it is determined that the acceleration pedal is operated; entering a stop mode if it is determined that the brake pedal is operated; entering a driving mode if it is determined that the break is not operated; and determining whether or not the hybrid electric vehicle travels on the slope by using a signal input from the slope degree sensor.

According to the invention constructed as described above, when the hybrid electric vehicle travels on a slope, the vehicle can travel in a driving mode which can be determined according to a degree of the slope and an SOC of the battery, thereby previously preventing motor torque of the vehicle from being abruptly increased while traveling on the slope. As a result, a travel distance of the electric motor can be increased, and thus the running of the internal combustion engine is minimized, thereby enhancing the fuel efficiency by reducing the fuel consumption.

### BRIEF DESCRIPTION OF THE DRAWINGS

The foregoing and other objects and features of the present invention will be more clearly understood from the following detailed description taken in conjunction with the accompanying drawings, in which:

FIG. 1 is a view illustrating the construction of a power train of a conventional hard-type hybrid electric vehicle;

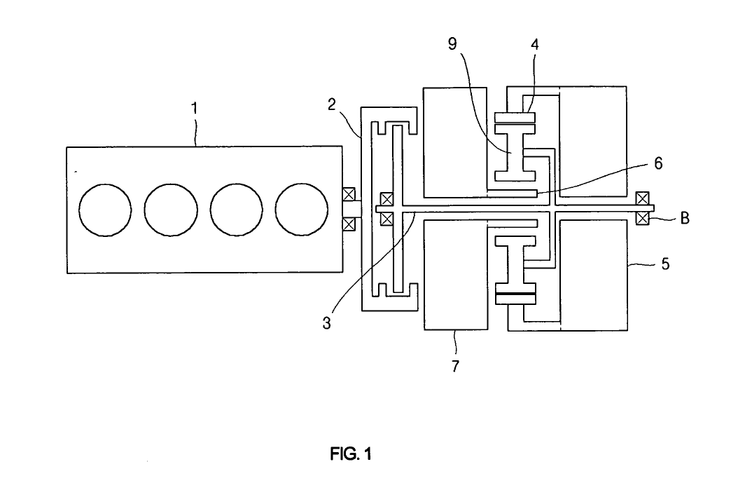

FIGS. 2a to 2d are views illustrating driving modes of the conventional hybrid electric vehicle;

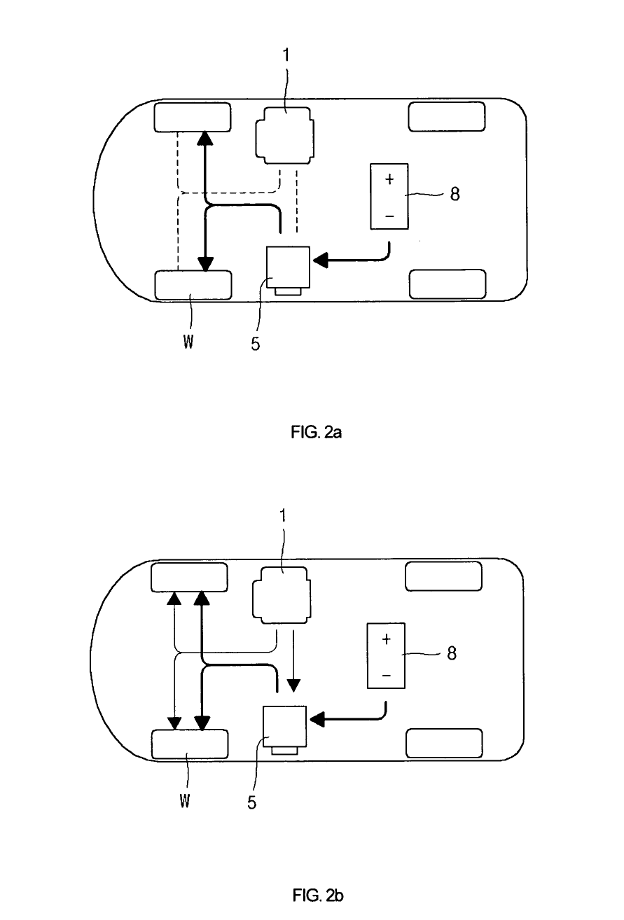

FIG. 3 is a graph depicting a driving force according to a travel speed of the conventional hybrid electric vehicle;

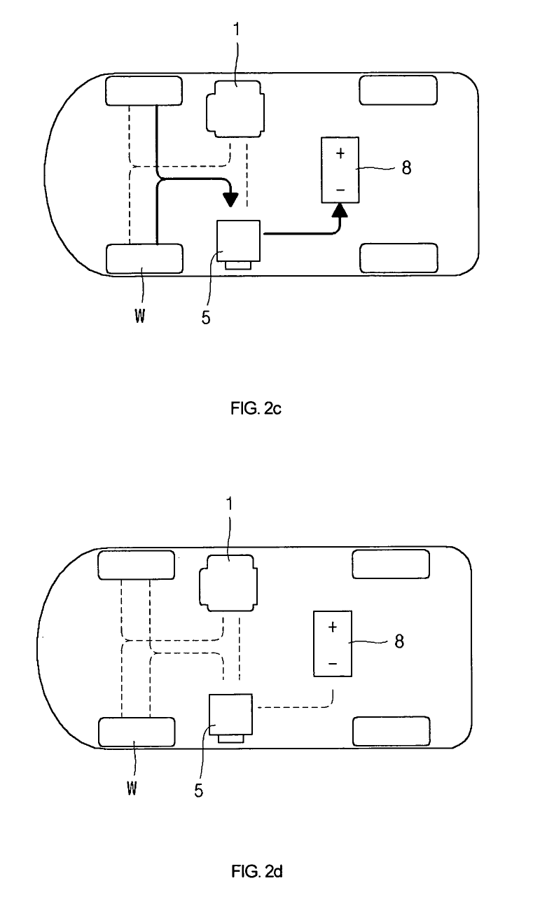

FIG. 4 is a block diagram illustrating the construction of an apparatus for controlling driving of a hybrid electric vehicle on a slope in accordance with one embodiment of the present invention;

FIG. 5 is a flow diagram illustrating a method for controlling driving of a hybrid electric vehicle on a slope in accordance with one embodiment of the present invention;

FIG. 6 is a diagram illustrating forces applied to the hybrid electric vehicle on the slope;

FIG. 7 is a view illustrating a table for determining a driving mode according to a slope degree and an SOC of a battery of the hybrid electric vehicle in accordance with one embodiment of the present invention; and

FIG. 8 is a graph illustrating correlation between a torque in a slope driving mode and a rotating number of engine/motor of the hybrid electric vehicle of one embodiment.

### DESCRIPTION OF THE PREFERRED EMBODIMENTS

Preferred embodiments will now be described in detail with reference to the accompanying drawings.

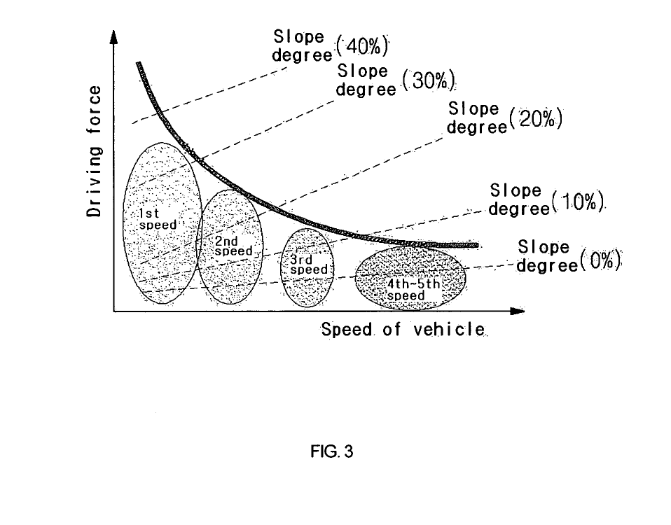

Referring to FIG. 4, a block diagram of illustrating the construction of an apparatus for controlling driving of a hybrid electric vehicle on a slope in accordance with one embodiment of the present invention is shown.

As shown in FIG. 4, the apparatus for controlling driving of the hybrid electric vehicle on the slope of the embodiment comprises an acceleration position sensor (APS) 10 to detect a position of an accelerator pedal, and output the position as an electric signal; a brake pedal sensor 20 to detect operation of the break pedal, and output the operation thereof as an electric signal; a slope degree sensor 30 to detect a slope degree of the hybrid electric vehicle, and output the slope degree of the vehicle as an electric sensor; a battery state of charge (SOC) sensor 40 to detect an SOC of a battery, and output the SOC of the battery as an electric signal; a hybrid electric vehicle control unit (HCU) 50 to select one mode among an engine-motor combined driving mode, an engine driving mode, and a motor driving mode according to the SOC of the battery and the slope degree by using the electric signals input from the SOC sensor 40 and the slope degree sensor 30, and output control signals; a battery 100 to supply power required for driving the electric motor 130; a charge control unit 60 to control the charge of the battery according to the control signal from the HCU 50; an engine control unit 70 to control an internal combustion engine 110 according to the control signal from the HCU 50; the internal combustion engine 110 to generate rotational force using gasoline fuel according to the control signal from the engine control unit 70; a generator control unit 80 to control a generator 120 according to the control signal from the HCU 50; the generator 120 to generate electric energy according to the control signal from the generator control unit 80; an electric motor control unit 90 to control an electric motor 130 according to the control signal from the HCU 50; and the electric motor 130 to generate rotating force using the electric energy according to the control signal from the HCU 50, in which the HCU 50 determines whether or not the acceleration pedal is operated by using the electric signal input from the acceleration position sensor 10, followed by entering a slow driving mode if it is determined that the acceleration pedal is not operated, determines whether or not the brake pedal is operated by using the electric signal input from the brake pedal sensor 20 if it is determined that the acceleration pedal is operated, followed by entering a stop mode if it is determined that the brake pedal is operated or by entering a driving mode if it is determined that the brake pedal is not operated, and determines that the hybrid electric vehicle travels on a slope by using the electric signals input from the slope degree sensor 30 when the hybrid electric vehicle travels on the slope, followed by entering a slope driving mode if it is determined that the acceleration pedal is operated and the brake pedal is not operated by using the electric signals from the acceleration position sensor 10 and the brake pedal sensor 20.

According to the present invention, the HCU 50 comprises database of the slope driving mode divided into various control regions representing the engine-motor combined driving mode, the engine driving mode, and the motor driving mode according to the SOC of the battery and the slope degree in order to select a driving mode suitable for the slope degree and the SOC of the battery in the slope driving mode.

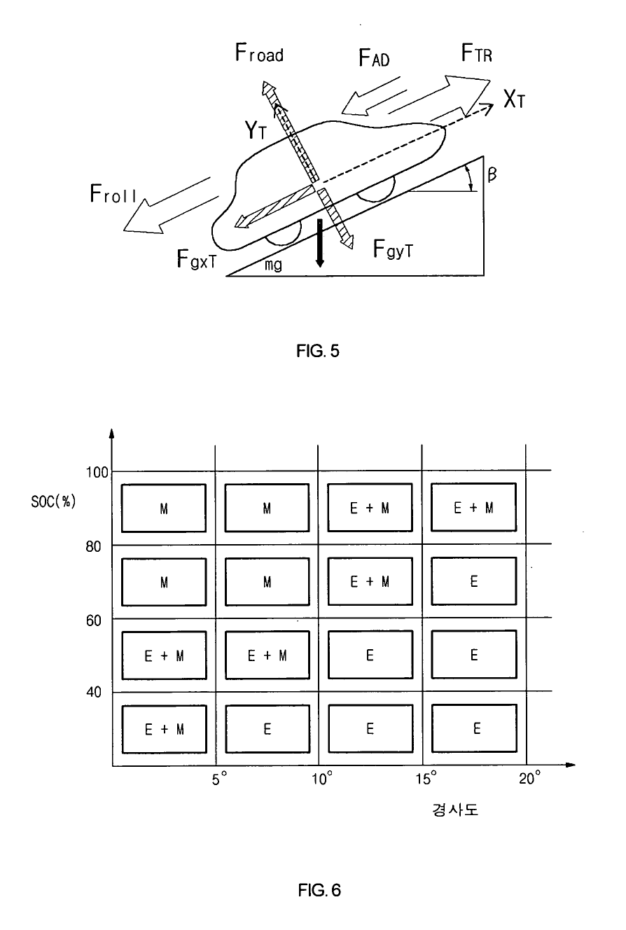

FIG. 6 is a diagram illustrating forces applied to the hybrid electric vehicle of the embodiment on the slope.

As can be seen from FIG. 6, a Road Load Force F_{RL} is calculated by the following Equation:
F_{RL}=F_{gxT}+Fᵣₒₗₗ+F_{AD}

Here, F_{gxT} indicates a force in an x-axis direction calculated by mg·sin β, Fᵣₒₗₗ indicates a rolling resistance force, and F_{AD} indicates an aerodynamic drag force. In addition, in FIG. 6, F_{TR} indicates a traction force, and F_{gyT} indicates a force in a y-axis direction calculated by mg·cos β.

In addition, Fᵣₒₗₗ is calculated by the following Equation:

$$\begin{matrix}\begin{matrix}{F}_{roll} = sgn [ {V}_{XT} ] \cdot mg \cdot \{ {C}_{0} + {C}_{1} \cdot {( {V}_{XT} )}^{2} \} & if {V}_{XT} \neq 0 \\ = ( {F}_{TR} - {F}_{gxT} ) & if {V}_{XT} = 0 , \vert {F}_{TR} - {F}_{gxT} \vert \leq {C}_{0} \cdot mg \\ = sgn [ {F}_{TR} - {F}_{gxT} ] \cdot ( {C}_{0} \cdot mg ) & if {V}_{XT} = 0 , \vert {F}_{TR} - {F}_{gxT} \vert > {C}_{0} \cdot mg\end{matrix} \\ ( sgn [ {V}_{XT} ] = 1 , if {V}_{XT} \geq 0 ; sgn [ {V}_{XT} ] = - 1 , if {V}_{XT} < 0 )\end{matrix}$$

Here, C₀ indicates a general coefficient of rolling resistance, and has a value in the range 0.004<<C₀<<0.02. In addition, C₁ indicates a coefficient of dynamic friction resistance, which is in proportion to a speed, and divided by the unit of S²/m². C₁ is much smaller than C₀, and can be represented by C₁<<C₀.

In order to prevent the hybrid electric vehicle from slipping on the road, the rolling resistance force of the vehicle must be high. In calculation of the rolling resistance force, it can be understood that the weight of the vehicle has the strongest influence, and thus it is necessary to control the weight of the vehicle so as to meet the requirement for Fᵣₒₗₗ. In other words, the weight of the vehicle must be controlled until the requirement of F_{TR}−Fᵣₒₗₗ>0 is satisfied.

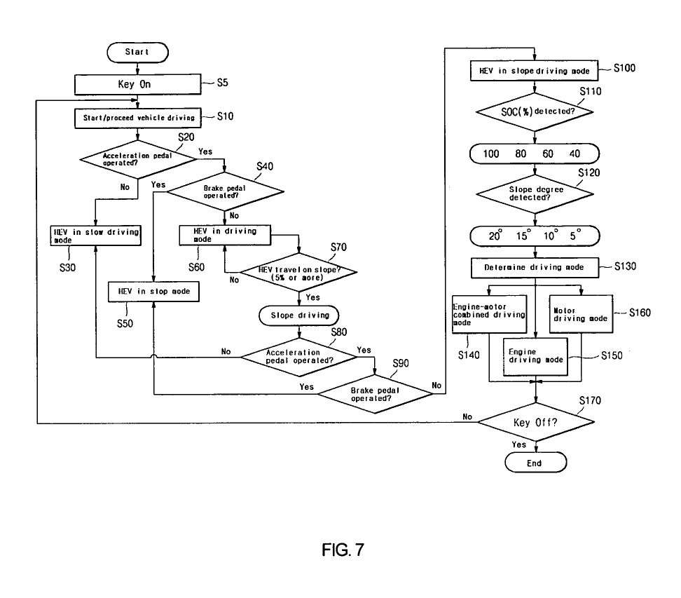

In FIG. 7, the database of the slope driving mode, which comprises various control regions representing the driving modes determined according to the slope degree and the SOC of the battery while experimentally satisfying the requirement described above, is shown.

Referring to FIG. 7, the database of the slope driving modes is composed of a table, which comprises a plurality of control regions divided by a slope degree axis, and an SOC axis, in which the slope degree axis is divided into 5 degrees, 10 degrees, 15 degrees and 20 degrees, and the SOC axis is divided into 40%, 60%, 80% and 100%.

Among the control regions, “E+M” indicates the engine-motor combined driving mode, “E” indicates the engine driving mode, and “M” indicates the motor driving mode.

As shown in FIG. 7, i) in a control region of slope degree<10° and 60%≦SOC<100%, the vehicle is allowed to travel in the motor driving mode where the driving force is supplied only by the electric motor, ii) in a control region of slope degree≧5° and SOC<40%, and a control region of slope degree≧10° and SOC<60%, the vehicle is allowed to travel in the engine driving mode where the driving force is supplied only by the engine, and iii) in the remaining control regions, the vehicle is allowed to travel in the engine-motor combined driving mode where the driving force is supplied by the engine and the electric motor.

Since the hybrid electric vehicle travels in one of the modes selected from the database of the slope driving modes as described above, it can travel on the slope such that the power of the battery is prevented from being wasted, and used to its limit, and it can travel with the driving force of the electric motor when only the electric motor is required for the hybrid electric car to travel on the road after finishing traveling on the slope.

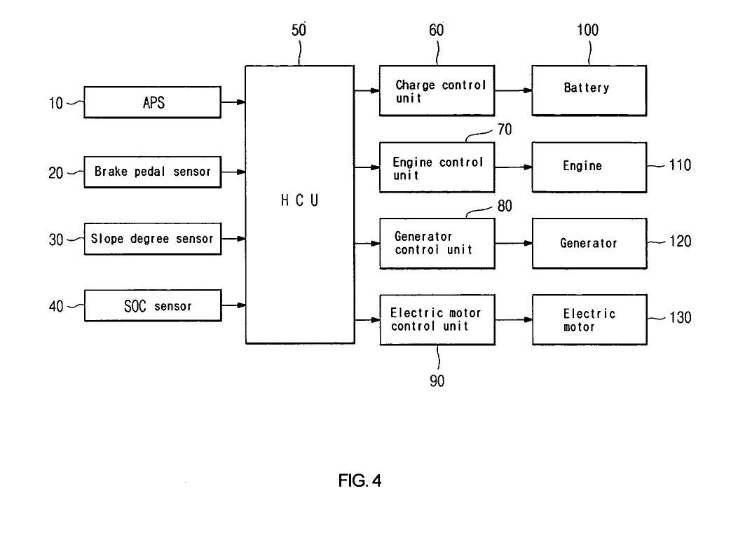

In FIG. 5, a flow diagram illustrating a method for controlling driving of a hybrid electric vehicle on a slope in accordance with one embodiment of the invention is shown.

Referring to FIG. 5, the method for controlling driving of the hybrid electric vehicle on the slope according to the embodiment comprises the steps of: turning on a key of the hybrid electric vehicle (S5); starting driving of the hybrid electric vehicle (S10); determining whether or not an acceleration pedal is operated by using a signal input from an acceleration position sensor (S20); entering a slow driving mode if it is determined that the acceleration pedal is not operated (S30); determining whether or not a brake pedal is operated by using a signal input from a brake pedal sensor if it is determined that the acceleration pedal is operated (S40); entering a stop mode if it is determined that the brake pedal is operated (S50); and entering a driving mode if it is determined that the break is not operated (S60).

According to the present invention, at the next step, it is determined whether or not the hybrid electric vehicle travels on a slope having a predetermined slope degree, for example, a slope degree of 5% or more, by using a signal input from a slope degree sensor in the driving mode (S70). If it is determined that the vehicle travels on the slope having a degree of 5% or more, the vehicle starts to perform slope driving, which allows the vehicle to travel on the slope.

However, even in the slope driving, if the acceleration pedal is not operated and the brake pedal is operated, the vehicle travels at a slow speed or stops, so that a slow driving mode or a stop mode is performed.

Accordingly, the steps of determining whether or not the acceleration pedal is operated by using a signal input from the acceleration position sensor (S80); determining whether or not the brake pedal is operated by using a signal input from the brake pedal sensor (S90); and determining that the vehicle is in a slope driving mode when the acceleration pedal is operated and the break pedal is not operated, followed by performing the slope driving mode (S100) are sequentially performed.

When the slope driving mode is performed, the steps of: detecting an SOC of a battery by using a signal input from an SOC sensor (S110); detecting a slope degree by using a signal input from the slope degree sensor (S120); and determining a driving mode according to the detected SOC and the slop degree (S130) are sequentially performed.

In the slope driving mode, one of the driving modes is selected from the database constructed of the table shown in FIG. 7 such that the selected driving mode is in a control region corresponding to the detected SOC and the slop degree.

As a result, the hybrid electric vehicle is driven in one of an engine-motor combined driving mode (S140), an engine driving mode (S150) and a motor driving mode (S160), and travels on the slope.

The method for controlling driving of the hybrid electric vehicle on the slope by the apparatus of the invention will be described in detail as follows.

When the hybrid electric vehicle starts to operate by applying power, the hybrid electric vehicle control unit 50 performs control related to driving of the vehicle to start driving of the hybrid electric vehicle (S10).

First, the HCU 50 determines whether or not the acceleration pedal is operated by using the signal input from the acceleration position sensor 10 (S20).

If it is determined that the acceleration pedal is not operated, the HCU 50 enters the slow driving mode (S30). In the slow driving mode, the HCU 50 controls the electric motor control unit 90 to allow the hybrid electric vehicle to be driven by the electric motor 130 to which power is supplied from the battery 100.

On the contrary, if it is determined that the acceleration pedal is operated, the HCU 50 determines whether or not the brake pedal is operated by using the signal input from the brake pedal sensor 20 (S40).

If it is determined that the brake pedal is operated, the HCU 50 enters the stop mode (S50). In the stop mode, the HCU 50 controls to stop both engine 110 and electric motor 130, thereby reducing unnecessary fuel consumption and emissions.

On the contrary, if it is determined that the brake pedal is not operated, the HCU 50 enters the driving mode (S60). In the driving mode, the HCU 50 controls the engine 110 and the electric motor 130 to operate at the same time such that the hybrid electric vehicle can travel with the highest fuel efficiency.

In the driving mode, the HCU 50 determines whether or not the hybrid electric vehicle travels on a slope having a slope degree of 5% or more, by using a signal input from the slope degree sensor 30 (S70). If it is determined that the vehicle travels on the slope having the slope degree of 5% or more, the slope driving of the vehicle is performed.

In the slope driving state, the HCU 50 determines whether or not the acceleration pedal is operated by using a signal input from the acceleration position sensor (S80), and then determines whether or not the brake pedal is operated by using a signal input from the brake pedal sensor if it is determined that the acceleration pedal is operated (S90).

If it is determined that the acceleration pedal is not operated in the slope driving state, the HCU 50 enters the slow driving mode (S30), and if it is determined that the brake pedal is operated in the slope driving state, the HCU 50 enters the stop mode (S50).

However, in the slope driving state, if it is determined that the acceleration pedal is operated, and the brake pedal is not operated, the HCU 50 enters the slope driving mode (S100).

In the slope driving mode, the HCU 50 determines a driving mode according to an SOC of the battery and a degree of the slope in order to previously prevent the power of the battery from reaching its limit due to an abrupt increase of motor torque. For this purpose, the HCU 50 detects the SOC of the battery by using a signal input from the SOC sensor 40 (S110), and then detects the slope degree by using a signal input from the slope degree sensor 30 (S120).

Then, the HCU 50 determines the driving mode according to the SOC and the slop degree detected at the above steps (S130).

For example, if 5°≦slope degree<10°, and 40%≦SOC<60%, the HCU 50 selects the engine-motor combined driving mode, and if 15°≦slope degree<20°, and 60%≦SOC<80%, the HCU 50 selects the engine driving mode.

As such, when the driving mode is determined on the table shown in FIG. 6, the HCU 50 enters the engine-motor combined driving mode (S140), the engine driving mode (S150), or the motor driving mode (S160) which is determined as the driving mode on the slope, and then the vehicle can travel on the slope.

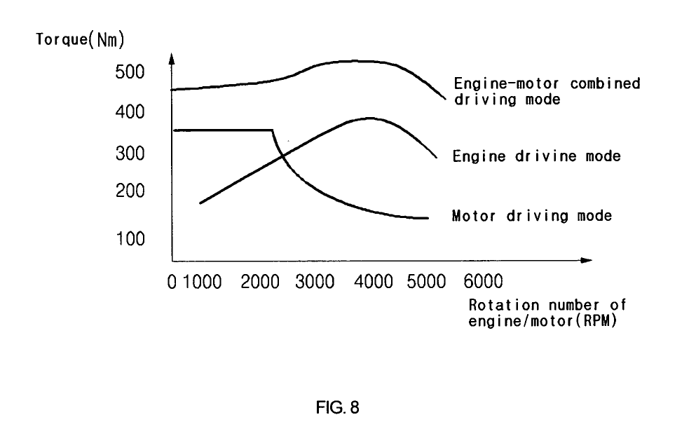

FIG. 8 is a graph illustrating correlation between a torque generated during the respective driving modes of the slope driving mode and a rotation number of engine/motor of the hybrid electric vehicle of one embodiment.

As apparent from the above description, according to the present invention, the vehicle can travel in a driving mode which can be determined according to the degree of the slope and the SOC of the battery when the hybrid electric vehicle travels on a slope, so that the motor torque of the vehicle is previously prevented from being abruptly increased when traveling on the slope. As a result, a travel distance of the electric motor can be increased, and the running of the internal combustion engine is minimized, thereby enhancing the fuel efficiency via reduction in fuel consumption.

It should be understood that the embodiments and the accompanying drawings have been described for illustrative purpose and the present invention is limited by the following claims. Further, those skilled in the art will appreciate that various modifications, additions and substitutions are allowed without departing from the scope and spirit of the invention as set forth in the accompanying claims.

What is claimed is:

1. An apparatus for controlling driving of a hybrid electric vehicle on a slope, comprising:
an acceleration position sensor to detect a position of an accelerator pedal and output the position as an electric signal;
a brake pedal sensor to detect operation of the break pedal and output the operation as an electric signal;
a slope degree sensor to detect a slope degree and output the slope degree as an electric sensor;
an SOC sensor to detect an SOC of a battery and output the SOC as an electric signal;
a hybrid electric vehicle control unit to receive the electric signals input from the acceleration position sensor, the brake pedal sensor, the slope degree sensor, and the SOC sensor, and to output control signals thereto; and
a driving unit to drive an engine, a generator, and an electric motor,
wherein, when the hybrid electric vehicle travels on a slope, the hybrid electric vehicle control unit selects one driving mode among an engine-motor combined driving mode, an engine driving mode, and a motor driving mode by using the electric signals input from the slope degree sensor and the SOC sensor, and controls the driving unit with the selected mode.

2. The apparatus as set forth in claim 1, wherein the hybrid electric vehicle control unit enters a driving mode when it is determined that the acceleration pedal is operated and the brake pedal is not operated by using the electric signals input from the acceleration position sensor and the brake pedal sensor, and
wherein, if it is determined that the hybrid electric vehicle travels on the slope by using the electric signal input from the slope degree sensor in the driving mode, and then if it is determined that the acceleration pedal is operated and the break pedal is not operated upon traveling on the slope by using the electric signal input from the acceleration position sensor and the brake pedal sensor, the hybrid electric vehicle control unit enters a slope driving mode, and selects one mode among the engine-motor combined driving mode, the engine driving mode, and the motor driving mode.

3. The apparatus as set forth in claim 1, wherein the hybrid electric vehicle control unit is provided with a table comprising a plurality of control regions divided by a slope degree axis divided into a plurality of preset slope degrees, and by an SOC axis divided into a plurality of preset SOCs, and
wherein, among the control regions of the table, a control region with a relatively high SOC and a relatively low slope degree is determined as the motor driving mode, a control region with a relatively low SOC and a relatively high slope degree is determined as the engine driving mode, and a control region between the control regions determined as the motor driving mode and the engine driving mode is determined as the engine-motor combined driving mode.

4. The apparatus as set forth in claim 3, wherein the control regions of the table are divided by the slope degree axis divided into 5 degrees, 10 degrees, 15 degrees, and 20 degrees, and by the SOC axis divided into 40%, 60%, 80%, and 100%, and
wherein, among the control regions, a control region of slope degree<10° and 60%≦SOC<100% is determined as the motor driving mode, a control regions of slope degree≧5° and SOC<40% and a control region of slope degree≧10° and SOC<60%, are determined as the engine driving mode, and the remaining control regions are determined as the engine-motor combined driving mode.

5. A method for controlling driving of a hybrid electric vehicle on a slope is provided, the method comprising the steps of:
determining whether or not the hybrid electric vehicle travels on a slope of a preset slope degree or more by using a signal input from a slope degree sensor;
detecting an SOC of a battery by using a signal input from an SOC sensor, and a degree of the slope by using a signal input from the slope degree sensor if it is determined that the hybrid electric vehicle travels on the slope; and
selecting one mode from an engine-motor combined driving mode, an engine driving mode, and a motor driving mode according to the detected SOC of the battery and the degree of the slope.

6. The apparatus as set forth in claim 5, wherein, after the step of determining whether the hybrid electric vehicle travels on the slope, the method further comprises:
entering a slope driving mode if it is determined that the hybrid electric vehicle travels on the slope, and if is it determined that the acceleration pedal is operated and the break pedal is not operated by using a signal input from the acceleration position sensor and the brake pedal sensor, followed by detecting the SOC of the battery and the degree of the slope.

7. The apparatus as set forth in claim 5, wherein, before the step of determining whether or not the hybrid electric vehicle travels on the slope, the method further comprises:
determining whether or not the acceleration pedal is operated by using a signal input from the acceleration position sensor when the hybrid electric vehicle starts to drive;
entering a slow driving mode if it is determined that the acceleration pedal is not operated;
determining whether or not the brake pedal is operated by using a signal input from the brake pedal sensor if it is determined that the acceleration pedal is operated;
entering a stop mode if it is determined that the brake pedal is operated;
entering a driving mode if it is determined that the break is not operated; and
determining whether or not the vehicle travels on the slope by using a signal input from the slope degree sensor.

8. The apparatus as set forth in claim 5, wherein at the step of selecting one mode, the mode is selected according to the SOC of the battery and the degree of slope such that the battery serving to supply electric power to the electric motor does not reach a limit that the battery cannot supply the electric power to the electric motor.
